(19) United States
(12) Patent Application Publication
(10) Pub. No.: US 2009/0233034 A1
(43) Pub. Date: Sep. 17, 2009

(54) TILING ADHESIVE APPLICATION SYSTEM

(76) Inventor: Stuart Edward Saunders, Great Yarmouth Norflolk (GB)

Correspondence Address: BROOKS KUSHMAN P.C., 1000 TOWN CENTER, TWENTY-SECOND FLOOR, SOUTHFIELD, MI, 48075, US

(21) Appl. No.: 12/441,199

(22) PCT Filed: Sep. 11, 2007
(86) PCT No.: PCT/GB2007/050533

§ 371 Date: Mar. 13, 2009

(30) Foreign Application Priority Data
Sep. 13, 2006 (GB) 0618026.9
Sep. 29, 2006 (GB) 0619180.3
Jun. 21, 2007 (GB) 0712031.4

(51) Int. Cl. C09J 7/00; E04F 15/00; E04F 13/00

(52) U.S. Cl. 428/41.8

(57) ABSTRACT

A tiling adhesive application system comprises a backing sheet with a series of parallel grooves extending thereacross and each carrying a bead of tiling adhesive. A release sheet is bonded to the edge margins of the backing sheet to form a sealed package. The backing sheet is transparent and of the same size as a tile to be adhered to a wall. The release sheet is peeled away to expose the adhesive which is then applied to the wall while carried by the backing sheet, whereafter the backing sheet is lifted away from the wall leaving the adhesive ready to bond a tile to the wall.

This invention relates to a tiling adhesive application system, particularly (but not exclusively) suitable for the tiling of walls and floors.

The usual technique for applying tiling adhesive to a surface to be tiled is to employ a hand-held spreader tool having a blade with a plurality of grooves along one edge. That tool, or perhaps another spreader, is loaded with adhesive from a container thereof and then that adhesive is spread over an area to be tiled, in order to have on the surface a layer of adhesive of more or less uniform thickness. The notched edge of the spreader is then used to create a series of generally parallel beads of adhesive extending across that area, with each bead being of essentially the same height and width. Once done, tiles are pressed into engagement with the beads of adhesive, with the appropriate gaps between the adjacent tiles.

The above technique suffers from the disadvantage that both the spreader and the exterior of the container tend to become coated in adhesive and so most inconvenient to use. Further, adhesive is likely to fall from the spreader both as the spreader is being moved from the container to the surface to be tiled, and also during the course of spreading the adhesive over that surface. In addition, the technique is relatively slow to perform in that three separate steps are required, being the loading of the spreader from the container, the application of a uniform layer of adhesive to the surface and then the scraping of excess adhesive to leave the beads on the surface. The third step wastes a significant quantity of adhesive, leading to increased costs.

It is also known to dispense tiling adhesive from a tube thereof and having a nozzle, so that a bead of adhesive may be created directly on the surface to be tiled, or perhaps on the reverse face of a tile. Further, it is also known for the nozzle to have a plurality of outlets, such that a plurality of beads are formed simultaneously on the surface to be tiled or on the reverse face of a tile. Though this technique generally involves less wastage and is not so messy to perform, it is not particularly convenient when a large area is to be tiled. An additional disadvantage is that only a relatively small volume of adhesive can be contained within the tube and moreover blocking of the nozzle frequently occurs.

It is a principal aim of the present invention to provide an application system for tiling adhesive which is both easy and convenient to perform, minimises wastage and moreover reduces the time required for the tiling of a given area.

According to this invention, there is provided a tiling adhesive application system comprising a backing sheet carrying a plurality of beads of adhesive in a generally parallel array extending across the sheet, the backing sheet being peelable from the beads of adhesive following the application thereof to an area to be tiled or to a tile to be adhered to an area, while the beads are still carried by the backing sheet.

It will be appreciated that with the system of this invention, a backing sheet is pre-loaded with beads of adhesive of a suitable cross-sectional area and spacing for the purpose of adhering tiles to a surface. The beads of adhesive are applied to the surface to be tiled (which term is used herein also to refer to the reverse face of a tile, for a case where the adhesive is applied to that face of a tile rather than the surface to be tiled) by pressing the backing sheet carrying the beads of adhesive into engagement with the surface. Then, the backing sheet is peeled away so leaving the beads of adhesive on the surface, whereafter tiling may proceed in the conventional manner. Thus, there should be no wastage of adhesive with this system which moreover is rapid and easy to perform.

Preferably, the surface of the backing sheet on which said beads of tiling adhesive are carried is treated to give the backing sheet release properties with respect to the tiling adhesive. This will permit easy peeling of the backing sheet once the beads have been pressed into engagement with the surface to be tiled.

In order to maintain the characteristics of the tiling adhesive as manufactured, it is highly preferred that a release sheet is laid over the faces of the beads remote from the backing sheet. Such a release sheet advantageously is bonded to the backing sheet around the edges thereof. To that end, the backing sheet preferably has an upstanding lip around the edges thereof, to which the release sheet is bonded. Conveniently, that lip may have an out-turned margin to which the border region of the release sheet is bonded or sealed.

In a particularly preferred embodiment, the backing sheet is provided with a series of grooves extending thereacross, one bead of tiling adhesive being disposed in each groove respectively. Such grooves should be arranged in a parallel array, with a spacing equal to that required for the spacing of the beads of adhesive when applied to a surface to be tiled. Further, the depth of such grooves should be substantially equal to the required height of the beads of adhesive.

A backing sheet with grooves as described preferably is resistant to crushing in a direction substantial normal to the general plane of the backing sheet, in order to allow a plurality of such backing sheets carrying adhesive to be stacked one upon another, for transport and storage. Thus, the backing sheet may be substantially rigid and conveniently is formed from a sheet of plastics material, by a moulding operation such as vacuum forming. In this case, the release sheet conveniently comprises a relatively thin sheet of plastics material or a foil, hermetically sealed to the backing sheet but peelable therefrom, in order to form a closed pack which may easily be opened when required for use.

Preferably, the backing sheet is of rectangular outer shape and has outer dimensions corresponding to a selected one of conventional tile sizes, whereby the application of the beads of adhesive of the application system to a surface to be tiled allows a single tile to be adhered to that surface. Of course, it would instead be possible to use such a system to apply adhesive to the reverse face of a single tile and then to press the tile to the surface to be tiled, in the required position. In either case, the length of each bead of adhesive preferably is slightly less than the width of the conventional tile to be adhered to a surface by means of the beads of adhesive.

As an alternative to the above, the beads of adhesive may be laid lengthwise along a web of backing sheet which is then wound into a roll, though possibly with a release sheet laid over the beads of adhesive before the winding operation. Then, a required length of the backing sheet may be cut from the roll and the beads of adhesive applied to a surface to be tiled, whereafter a plurality of tiles may be adhered to that surface.

It is preferred that the backing sheet is of a transparent material and conveniently plastics. This aids the application of the backing sheet carrying the tiling adhesive to the required area to be tiled, or even to a tile, in the event that the tile is slightly smaller than the backing sheet. It will also assist cutting of the application system for tiling at the edge of an area to be tiled, or if tiling is to be performed around an obstruction.

Conventional tiling adhesive intended for application to a surface to be tiled either by a spreader or dispensed from a tube has a relatively low viscosity and, before application to a wall, is flowable to a limited extent. On application of the adhesive to a surface to be tiled, moisture is drawn from the adhesive and so the adhesive then tends to stay where applied. By contrast, it is preferred that the adhesive employed with the tiling system of this invention is significantly more viscous (or “stiff”) than such conventional tiling adhesive, in order that the beads may stay intact as deposited on the backing sheet. This may be achieved by adding a percentage of a chemical that thickens the adhesive, such as a polyacrylic rheology modifier. Also, the composition may include a component to increase the tackiness thereof, such as those products known as AcResin or Acronal.

The composition of the adhesive preferably is such that though initially relatively viscous, the adhesive rapidly becomes less so following the application thereof to a surface. This could be achieved by an appropriate chemical composition for the adhesive, so that on release of the adhesive from a sealed pack the viscosity reduces by contact with air. Another possibility would be to contact the adhesive with water to reduce its viscosity. This could be done by spraying the beads of adhesive whilst still carried by the backing sheet but before application of the beads to a surface, or following the application of the adhesive to a surface, for example by using a fine water spray. Another possibility for a case where the beads of adhesive are applied to the reverse face of a tile would be to dip the tile into a container of water.

By way of example only, various specific embodiments of tiling adhesive application system of this invention will now be described in detail, reference being made to the accompanying drawings in which:

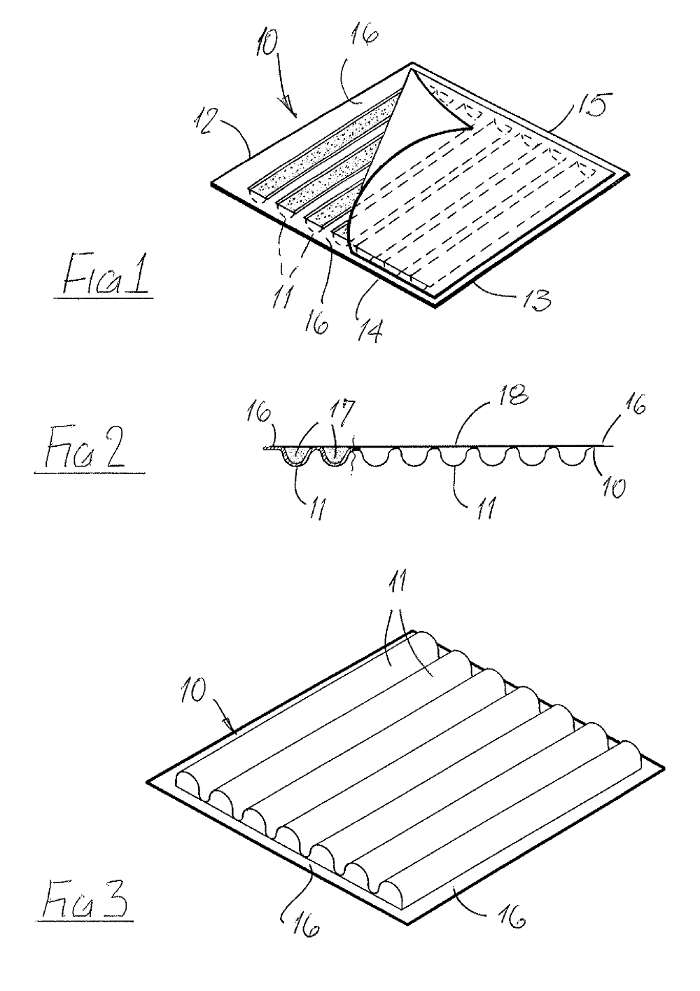

FIG. 1 is an isometric view of the preferred embodiment of tiling adhesive application system, with the release sheet partially peeled;

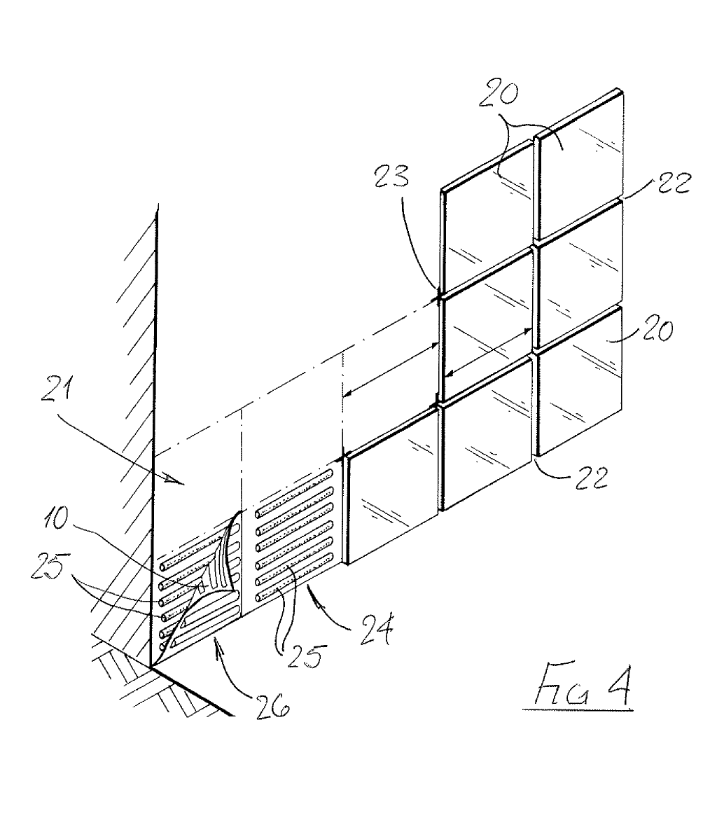

FIG. 2 is an end view, partly in cross-section, of the system of FIG. 1;

FIG. 3 is an isometric view of the underside of the system of FIG. 1;

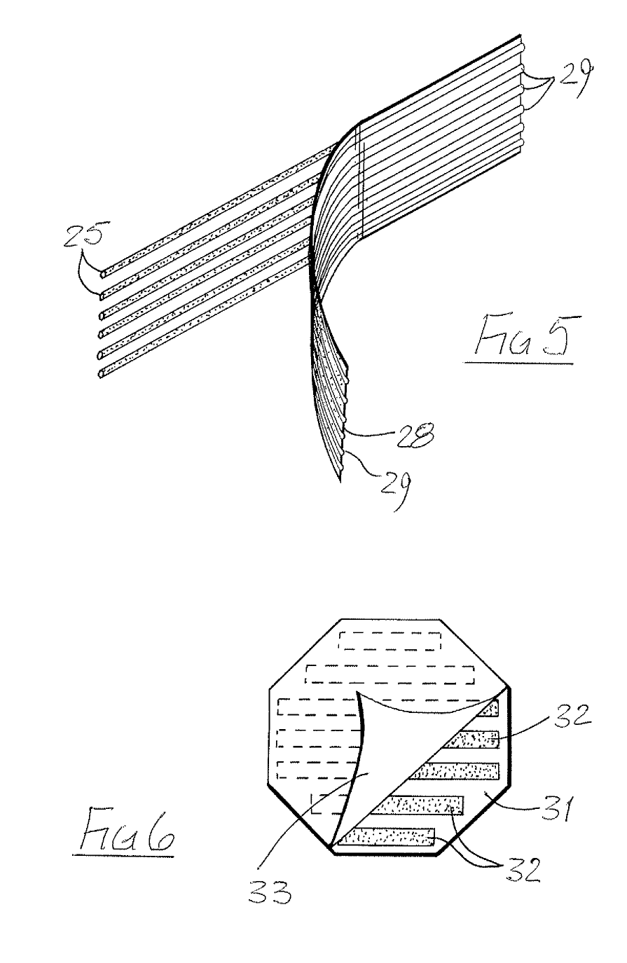

FIG. 4 illustrates use of the tiling adhesive application system;

FIG. 5 shows an alternative tiling adhesive application system;

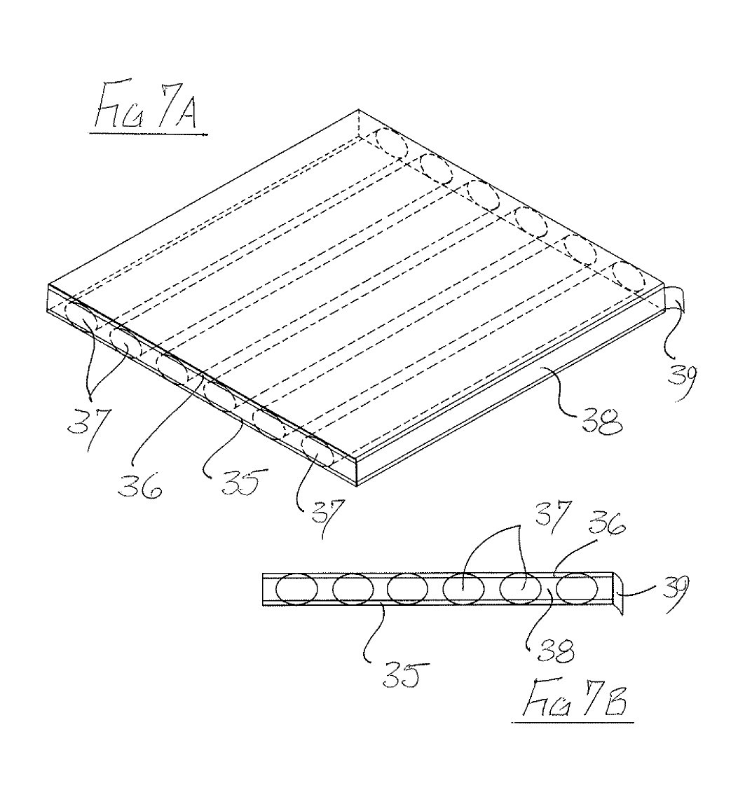

FIG. 6 shows a tiling adhesive application system intended for use with octagonal tiles; and

FIGS. 7A and 7B are respectively isometric and end views on yet another embodiment of tiling adhesive application system.

Referring initially to FIGS. 1 to 3, there is shown a first embodiment of tiling adhesive application system. This comprises a backing sheet 10 of a relatively hard plastics material pre-formed—for example by a vacuum moulding technique—to have a series of parallel troughs 11 or grooves extending across a face of the backing sheet. Each trough 11 is of generally semi-circular shape and extends parallel to opposed first and second edges 12 and 13 of the backing sheet, from locations adjacent but spaced from opposed third and fourth edges 14 and 15. In this way, there are margins 16 around the sheet, adjacent each edge 12 to 15.

Contained in each trough 11 is pre-mixed tiling adhesive 17. The trough is substantially filled with the adhesive both for the full length of the trough and the full depth thereof. A release sheet 18 overlies the face of the backing sheet 10 into which the troughs open and is sealed to the margins 16 such that the adhesive 17 is in an hermetically-sealed environment. As shown in FIG. 1, the dimensions of the release sheet may be slightly smaller than those of the backing sheet. In the alternative, the release sheet may have essentially identical dimensions to those of the backing sheet or may be slightly larger, in order to allow grasping of the release sheet, to permit it to be peeled away from the backing sheet, as shown in FIG. 1. Yet another possibility would be to provide one or more tabs on the release sheet, projecting beyond the edges of the backing sheet and manually grippable to facilitate peeling away of the release sheet.

Typically, the backing sheet is made from transparent PVC or a similar plastic which readily lends itself to forming as shown in the drawings. The release sheet may also be of PVC or could be of another suitable grade of plastics material which may be heat-sealed to PVC. Depending upon the plastics material employed for the backing sheet and release sheet, as well as the characteristics of the adhesive, the surfaces of the backing sheet and release sheet which contact the adhesive may be treated in order to minimise the likelihood of the adhesive adhering thereto.

The adhesive contained within the troughs 11 may be similar to conventional tiling adhesives though it is preferred that the adhesive is relatively more viscous (or stiff) than conventional adhesives. This will resist the adhesive within the troughs moving to one end of the troughs, in the event that the packed adhesive is stacked on edge. An example of a suitable tiling adhesive is a mixture of about 1% Rheovis ATX (a highly effective associative polyacrylic rheology modifier) and about 3% Acronal (a tackifier) with the balance being a conventional tiling adhesive.

FIG. 4 illustrates the use of the tiling adhesive application system, to adhere rectangular tiles to a wall, each tile being of essentially the same dimensions as the backing sheet of the application system. Tiles 20 have already been adhered to wall 21 with the appropriate gaps 22 between the tiles, created by X-shaped separators 23. A patch of adhesive 24, consisting of parallel beads 25 of adhesive has already been applied to the wall ready for the next tile to be laid in the bottom row thereof. A further patch 26 of adhesive is shown being applied using the application system of this embodiment.

The adhesive is applied by peeling away the release sheet 18 from the backing sheet 10 of an application system and discarding that release sheet. The exposed surfaces of the beads of adhesive are wetted with a fine spray of water in order that the viscosity thereof is reduced and then the backing sheet is offered to the wall 21 at the required location. The backing sheet has the overall dimensions of the next tile to be laid and so can be used to assist positioning on the grid pre-marked on a wall, for the tiles. Once at the right position, pressure is applied to the backs of the troughs 11 so as to press the adhesive into engagement with the wall. Thereafter, as shown in FIG. 4, the backing sheet is bent away from the wall so as to come free of the beads of adhesive, whereafter the backing sheet is discarded.

By having a transparent backing sheet, positioning of the backing sheet is assisted. Moreover, before the release sheet is peeled away, the pack may be cut as required, for example when tiling to an edge or if the tiling is to go round an obstruction.

Though FIG. 4 shows two patches of adhesive applied to a wall, more usually a single patch would be applied and then a tile presented to that patch. This prevents the adhesive drying too much by absorption of moisture into the wall. Further, it greatly assists cleanliness in working.

FIG. 5 shows an alternative embodiment of tiling adhesive application system using much the same principles as has been described above. However, in the embodiment of FIG. 5 the backing sheet is in the form of an elongate web 28 with troughs 29 extending parallel to the length of the web. Though such a web could be provided with a peelable backing sheet, preferably it is wound into a roll such that the reverse face of the backing sheet serves as a release sheet for the next turn and protects the adhesive from drying out. When the system is to be employed, a required length is cut from the roll and is applied to a wall in the required location, after wetting with a fine spray if required. Such a system may be employed to allow the application of adhesive for a plurality of tiles, at the same time.

Instead of applying the adhesive directly to a wall, it may be applied to the reverse face of a tile. FIG. 6 shows an embodiment of tiling adhesive application system which may particularly lend itself for use in this way, with octagonal shaped tiles. The backing sheet 31 has an octagonal overall shape with seven troughs extending thereacross, each substantially filled with adhesive 32. A correspondingly release sheet 33 is sealed to the margins of the backing sheet 31 but can be peeled away as shown in FIG. 6, to permit wetting of the adhesive followed by the application of the backing sheet to an octagonal tile. Once pressure has been applied to the reverse face of the backing sheet to press the adhesive on to the tile, the backing sheet may be lifted away as has been described above with reference to FIG. 3.

FIGS. 7A and 7B show an alternative embodiment of tiling adhesive application system. Here, there is a substantially rigid planar backing sheet 35 and a similarly formed release sheet 36 with beads 37 of tiling adhesive laid between the sheets 35 and 36. A strippable edge band 38 is bonded to the edge margins of both sheets 35 and 36 and is substantially rigid in the direction perpendicular to the plane of sheets 35 and 36, so as to hold the sheets at the required spacing. The edge band 38 includes a tab 39 whereby the end of the band may be pulled away from the sheets 35 and 36, around the entire peripheries of those sheets. Thereafter one of the sheets 35,36 may be peeled away from the beads of adhesive. Once done, the application of the adhesive may proceed as has been described above with reference to the first embodiment.

1. A tiling adhesive application system comprising a backing sheet carrying a plurality of beads of adhesive in a generally parallel array extending across the sheet, the backing sheet being peelable from the beads of adhesive following the application thereof to an area to be tiled or to a tile to be adhered to an area, while the beads are still carried by the backing sheet.

2. A tiling adhesive application system as claimed in claim 1, wherein the surface of the backing sheet on which said beads are carried is treated to give the backing sheet release properties with respect to the tiling adhesive.

3. A tiling adhesive application system as claimed in claim 1, wherein the application system includes a release sheet laid over the faces of the beads remote from the backing sheet.

4. A tiling adhesive application system as claimed in claim 3, wherein the backing sheet has an upstanding lip around the edges thereof, the release sheet being bonded to the lip.

5. A tiling adhesive application system as claimed in claim 4, wherein the release sheet is sealed to the lip to form a substantially airtight package containing the tiling adhesive.

6. A tiling adhesive application system as claimed in claim 4, wherein the lip has an out-turned margin and the release sheet is bonded or sealed to said margin.

7. A tiling adhesive application system as claimed in claim 1, wherein the backing sheet is provided with a series of grooves extending thereacross, one bead of tiling adhesive being disposed in each groove, respectively.

8. A tiling adhesive application system as claimed in claim 7, wherein the backing sheet comprises a sheet of plastics material with the grooves being defined therein by a moulding operation on the sheet.

9. A tiling adhesive application system as claimed in claim 7, wherein the backing sheet is resistant to crushing in a direction substantially normal to the general plane of the sheet.

10. A tiling adhesive application system as claimed in claim 9, wherein the backing sheet is substantially rigid.

11. A tiling adhesive application system as claimed in claim 1, wherein the release sheet comprises a relatively thin sheet of plastics material or a foil hermetically to seal the tiling adhesive into a sealed pack.

12. A tiling adhesive application system as claimed in claim 1, wherein the backing sheet is of rectangular outer shape.

13. A tiling adhesive application system as claimed in claim 12, wherein the backing sheet has outer dimensions corresponding to a selected one of conventional tile sizes whereby the application of the beads of adhesive of the tiling adhesive application system to a surface the allows a single tile to be thereby adhered to the surface.

14. A tiling adhesive application system as claimed in claim 13, wherein the length of the beads of adhesive is less than the width of a conventional tile to be adhered to a surface thereby.

15. A tiling adhesive application system as claimed in claim 1, wherein the backing sheet is in the form of an elongate web with the beads of adhesive extending lengthwise thereof.

16. A tiling adhesive application system as claimed in claim 15, wherein the backing sheet carrying the beads of adhesive is wound into a roll from which a required length of backing sheet and beads of adhesive may subsequently be cut.

17. A tiling adhesive application system as claimed in claim 1, wherein the backing sheet is of a transparent material.

18. A tiling adhesive application system as claimed in claim 1, wherein each bead of tiling adhesive has a high viscosity relative to conventional tiling adhesive for manual application.

19. A tiling adhesive application system as claimed in claim 18, wherein the chemical composition of the tiling adhesive is such that the viscosity of the adhesive reduces when the adhesive is applied to a surface to be tiled or to a tile to be adhered to a surface.

20. A tiling adhesive application system as claimed in claim 18, wherein the chemical composition of the tiling adhesive is such that the viscosity of the adhesive is reduced on contact with water.

21. A tiling adhesive application system as claimed in claim 1, wherein the tiling adhesive comprises a conventional tiling adhesive including at least one of a thickening agent and a tackifier.
